(19) United States
(12) Patent Application Publication
(10) Pub. No.: US 2009/0044282 A1
(43) Pub. Date: Feb. 12, 2009

(54) System and Method for Generating and Displaying a Keyboard Comprising a Random Layout of Keys

(75) Inventor: Jothikumar GOVINDARAJU, Santa Clara, CA (US)

Correspondence Address: Greenberg Traurig, LLP (OnSpec/TPL), 2450 Colorado Avenue, Suite 400E, Santa Monica, CA, 90404, US

(73) Assignee: TECHNOLOGY PROPERTIES LIMITED, Cupertino, CA (US)

(21) Appl. No.: 11/836,761

(22) Filed: Aug. 9, 2007

(51) Int. Cl. H04L 9/32; G06F 7/58

(52) U.S. Cl. 726/27; 708/250

(57) ABSTRACT

Systems and methods for generating and displaying a keyboard comprising a random layout of keys are described here. One embodiment includes displaying a keyboard comprising a random layout of keys, to receive a user entered key phrase to be entered to gain access to secure data, and receiving the user entered key phrase by the user selecting keys of the keyboard via a pointing input device. The displaying includes, individually mapping keys of the keyboard to a separate value within a first value range, selecting a key for the keyboard based on the random value generated, and repeating the generating the random value and selecting a key for the keyboard based on the random value to select a remainder of keys for generating the random layout of keys for the keyboard.

### TECHNICAL FIELD

The present disclosure relates generally to a system and method for password security and specifically for, generating and displaying a keyboard comprising a random layout of keys.

### BACKGROUND

System event logging is typically used as a diagnostic and debugging technique in software development to determine sources of error in computer systems and may additionally be used to monitor employee productivity during business hours. Further, event logging may be used by law enforcement obtain passwords and/or encryption keys to bypass security measures.

In general, event loggers such as keystroke loggers can be used to capture keystrokes to determine sources of error in computer systems. However, keystroke logging may also be used by spy-ware and hackers to obtain passwords or encryption keys. Furthermore, key loggers can undergo mass distribution as a Trojan horse or as a part of a virus. The key logged data may then be downloaded later to retrieve the stolen information.

Data and information access is frequently authorized via passwords for identity verification. In some situations, the password entry, display and processing procedures have become weak links in security implementations. For examples, passwords are increasingly used for access to personal information such as financial information, healthcare information, insurance information, emails, computing systems, etc. However, in addition to key logging, there are several mechanisms under which password security could be breached thus threatening data security and personal privacy. Breach of password security may result in loss of privacy of personal information, medical information, financial loss, and identity theft. Moreover, with increased mobile access of sensitive information via wireless networks, password security is further compromised due to the ease with which portable devices are lost.

### SUMMARY OF THE DESCRIPTION

Systems and methods for generating and displaying a keyboard comprising a random layout of keys are described here. Some embodiments of the present disclosure are summarized in this section.

One embodiment includes a method, which may be embodied on a system of displaying a keyboard comprising a random layout of keys, to receive a user entered key phrase to be entered to gain access to secure data, and receiving the user entered key phrase by the user selecting keys of the keyboard via a pointing input device.

One embodiment further includes, individually mapping keys of the keyboard to a separate value within a first value range, generating a random value within the first value range, selecting a key for the keyboard based on the random value generated, and repeating the generating a random value and selecting a key for the keyboard based on the generated random value to select a remainder of keys for generating the random layout of keys for the keyboard.

One embodiment further includes, in response to receiving a key phrase input by the user to gain access to secured data, randomly selecting a set of substitute characters and providing the set of substitute characters in place of the key phrase entered by the user. In one embodiment, the randomly selecting includes using a random number generator to select a substitute character from a pre-generated set of substitute characters for each character, number, or text of the user entered key phrase. In one embodiment, the key phrase is one of a password and a security phrase.

One embodiment further includes providing the randomly selected set of substitute characters in a display buffer in place of the user entered key phrase. One embodiment further includes storing, in memory of a system, a representation of the user entered key phrase, the representation being different and separate from the randomly selected set of substitute characters, and comparing the representation of the user entered key phrase stored in the memory with a pre-stored value, to verify the user entered key phrase.

The present disclosure includes methods and apparatuses which perform these methods, including processing systems which perform these methods, and computer readable media which when executed on processing systems cause the systems to perform these methods.

Other features of the present disclosure will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1A is an example of a screenshot of an on-screen keyboard, according to one embodiment.

FIG. 1B is an example of a screenshot of an on-screen keyboard with a random layout of keys, according to one embodiment.

FIG. 1C is an example of a screenshot of an on-screen keyboard with a random layout of keys displayed in a scrambled bitmap, according to one embodiment.

FIG. 2 is an illustration of examples of various formats applied to an image to render scrambled bitmaps that are non-machine readable, according to one embodiment.

FIG. 3A is a flow chart illustrating a process to receive an input of a key phrase via a pointing device, according to one embodiment.

FIG. 3B is a flow chart illustrating a process to generate a keyboard with a random layout of keys, according to one embodiment.

FIG. 4 is a flow chart illustrating a process to verify a key phrase as entered by a user via an on-screen keyboard with a random layout of keys, according to one embodiment.

FIG. 5 is a flow chart illustrating a process to determine at least one rule to be applied to a key displayed on the on-screen keyboard to render the characters in the displayed key non-machine readable, according to one embodiment.

FIG. 6A is a table illustrating an exemplary set of rules to be applied to a displayed key and the binary mapping of the set of rules to determine the rules to be applied, according to one embodiment.

FIG. 6B is a table illustrating a random number and the binary representation of the random number, according to one embodiment.

FIG. 7 is a table illustrating a mapping of a position on a keyboard to a key to be displayed on the keyboard, according to one embodiment.

FIG. 8 is a flow chart illustrating a process to randomly select a substitute character to be provided and displayed in place of an input character of a key phrase entered by a user, according to one embodiment.

FIG. 9 is a table illustrating an exemplary set of pre-generated substitute characters to be randomly selected in place of a user entered key phrase, according to one embodiment.

FIG. 10 illustrates an example of implementing at least one embodiment to protect a user entered key phrase when attempting to access data via network connection.

FIG. 11 illustrates a block diagram of a machine-readable medium, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the present disclosure include systems and methods for generating and displaying a keyboard comprising a random layout of keys.

Protection of password confidentiality can be implemented in various stages of password usage. For example, since passwords can be tracked and logged by event tracking scripts or applications as they are being populated into a password field, an on-screen display keyboard is provided for password entry. In this situation, physical keyboard entry may be disabled for inputting characters in the password field.

In one embodiment, an on-screen keyboard with a random layout of keys is generated and displayed for example, when the password is to be entered. The random layout of keys can prevent a mouse event tracker from logging the mouse click activities potentially revealing passwords entered with the on-screen keyboard. A different layout can be applied each time a user logs on to the system. In one embodiment, a different layout can be applied after a pre-determined number of failed logon attempts, thus preventing an application or script from tracking incorrect combinations to deduce the correct key phrases.

In one embodiment, the random layout of keys is displayed in a non-machine readable format on the on-screen keyboard. For example, the keys can be displayed as a scrambled bitmap to prevent optical character recognition (e.g., OCR) enabled applications or scripts from reading the on-screen keyboard.

The methods of the present disclosure can be implemented on a computing system such as a laptop, a handheld device, a desktop computer, a cellular phone, etc. In one embodiment, the key phrase protection process is applied by the system to any application/script that prompts the user for a password. The protection can be applied to system passwords (e.g., a BIOS password, an operating system password, and/or an encryption key to decrypt encrypted data).

In one embodiment, the method of generating and displaying an on-screen keyboard is implemented in individual applications such as an email retrieval system, an online bill pay webpage, money management software, productivity tools, etc. Further, the password protection process can be provided by websites where confidential information such as financial data is typically accessed via password authentication.

A password (e.g., key phrase, pass phrase, keyword, security code, security phrase, etc.) that has been populated into a password field can be tracked and logged by various applications. In one embodiment, a set of substitute characters is generated in place of a user entered key phase entered via an on-screen keyboard with a random layout of keys. For example, the substitute characters can be selected randomly via a random number generating algorithm (e.g., the substitute characters can be alphanumeric, numbers, text, special characters, and/or alphabets).

In one embodiment, the substitute characters are masked by miscellaneous characters to be displayed on the screen. In addition, the substitute characters may be displayed on the screen without masking. In one embodiment, the randomly selected substitute characters are stored in the display buffer in place of the key phrase as entered by the user such that applications probing the display buffer will track and log an incorrect set of characters that is different from the key phrase entered by the user.

A representation of the user entered key phrase (e.g., a hash value of the user entered key phrase) can be stored in a memory location different from that of the memory storage location of the set of randomly selected substitute characters. Therefore, the user entered key phrase can be retained such that it can be compared with a pre-stored value of the key phrase in another location of memory to verify the user entered key phrase.

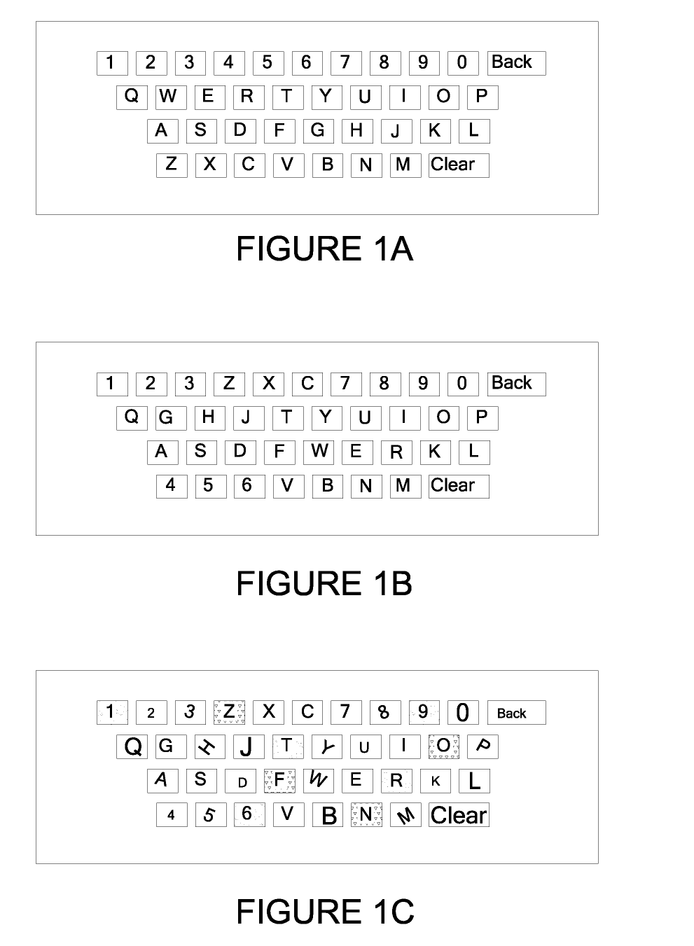

FIG. 1A is an example of a screenshot of an on-screen keyboard, according to one embodiment.

The on-screen keyboard can be generated and displayed when an identification verification is to be performed via password authentication such that the password can be entered from selecting the keys on the on-screen keyboard. The on-screen keyboard may be integrated with the password entry window. In one embodiment, the on-screen keyboard is a portion of a window separate from that of the password entry window.

In one embodiment, the passwords and/or other security keys are input via the on-screen keyboard. The keys of the on-screen keyboard can be selected via a mouse or any other pointing devices. In addition, the keys can be selected via physically to touching the screen with a pointing device such as a stylus or the user's hand. In one embodiment, the physical keyboard is disabled for entering values into the password and/or security key fields.

FIG. 1B is an example of a screenshot of an on-screen keyboard with a random layout of keys, according to one embodiment.

To prevent event loggers such as mouse event loggers from tracking mouse movement and position to determine the characters of a password entered via an on-screen keyboard via the pointing device position, the position of the keys on the on-screen keyboard can be displayed in a layout that is different from a conventional keyboard. For example, a layout of the keyboard can be randomly generated via a random number generating algorithm. A keyboard layout may be generated and displayed when a password prompt appears on the screen. In one embodiment, a different layout is applied after receiving a pre-determined number of requests to enter a password. A new layout may be generated in the event of invalid logon attempts to prevent event trackers from determining the correct password via eliminating the incorrect password combinations, by tracking and logging the keys selected with a pointing input device (e.g., a mouse).

FIG. 1C is an example of a screenshot of an on-screen keyboard with a random layout of keys displayed in a scrambled bitmap, according to one embodiment.

In one embodiment, the characters of the on-screen keyboard is displayed as a non-machine readable format. For example, the non-machine readable representation can be a scrambled bitmap thus preventing optical character recognition (e.g., OCR) enabled applications and/or scripts from reading the characters contained in a bitmap.

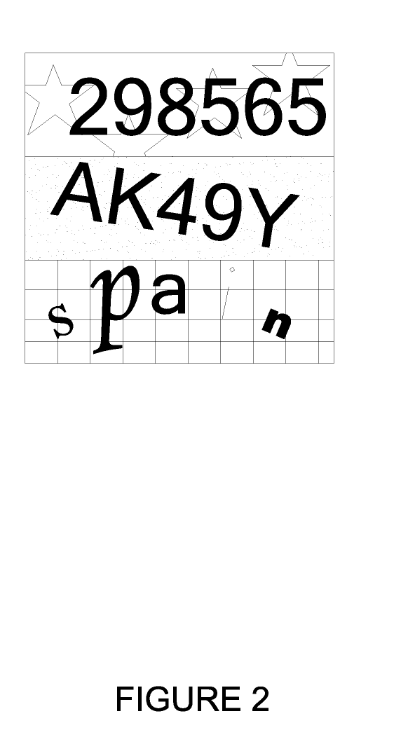

In one embodiment, a format is applied to distort one or more keys to display the one or more keys in a non-machine readable image. Some applicable formats are further illustrated in FIG. 2. In addition, a watermark can be applied to the one or more keys to generate the one or more keys as a non-machine readable format. A watermark can also be applied with other formats to scramble a bitmap, such as a custom font to generate non-machine readable images. In one embodiment, a watermark refers to an identifier associated with data such as an image. The identifier (e.g., a message, bits, numbers) may include information about the data such as the author of the image, the origin, and/or the data it contains, etc.

In one embodiment, the watermark is hidden in the image without knowledge of the user. For example, the watermark may be visible or invisible by the user. The visible watermark can alter the appearance of the original image thus rendering the original image non-machine readable. Multiple formats applied to scramble a bitmap can potentially deter malicious scripts and/or applications from determining the format applied to a bitmap. In one embodiment, the combination of applying a format to distort the one or more keys, and applying a watermark to the one or more keys is used to display the one or more keys in a non-machine readable image.

FIG. 2 is an illustration of examples of various formats applied to an image to render scrambled bitmaps that are non-machine readable, according to one embodiment.

In one embodiment, the non-machine readable representations are bitmaps, which represent the characters of the key in an image rather than in a textual format. The non-machine readable representations of the one or more keys can be used to protect the key displayed on the on-screen keyboard from being read by malicious applications. For example, applications and/or scripts can be programmed to automatically retrieve machine-readable text from a webpage, window, application, a particular field of a window, and/or a portion of the display. Other malicious applications may have optical character recognition capabilities and are able to read in non-machine readable representations of text.

In one embodiment, the non-machine readable representation is a scrambled bitmap thus preventing optical character recognition (e.g., OCR) enabled applications and/or scripts from reading the characters represented in a bitmap. As illustrated, the scrambled bitmap may include custom font characters, characters with various backgrounds (e.g., patterned, textured background, etc.), slanted text, warped text, text with various orientations, etc. Scrambled bitmaps such as a bitmap with colored characters can also be used.

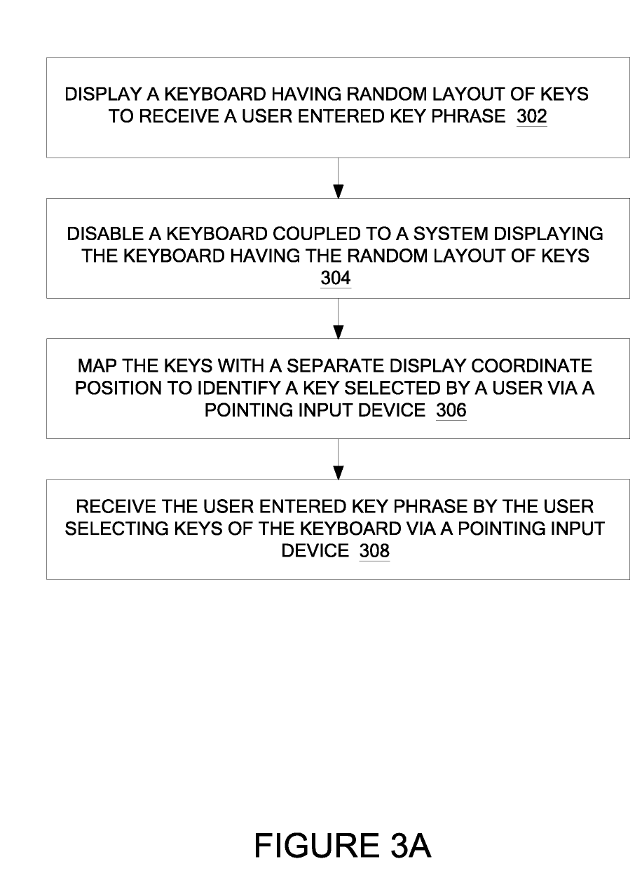

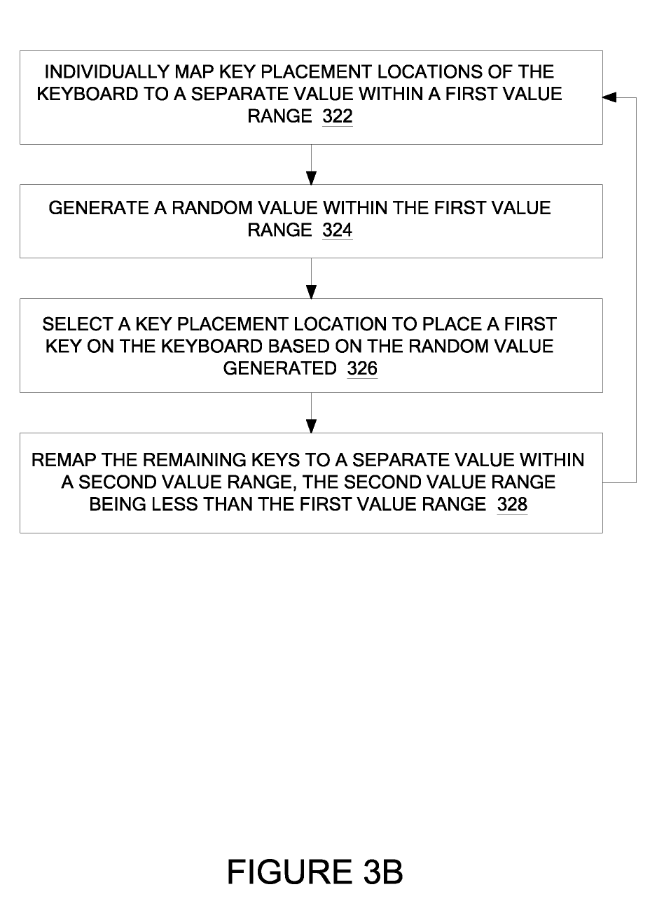

FIG. 3A is a flow chart illustrating a process to receive an input of a key phrase by a user via a pointing device, according to one embodiment.

In process 302, a keyboard having random layout of keys is displayed to receive a user entered key phrase. The keyboard is an on-screen keyboard that can be generated, according to an exemplary process illustrated in FIG. 3B, when a key phrase prompt is generated. In process 304, a keyboard coupled to a system displaying the keyboard having the random layout of keys is disabled such that the user uses the on-screen keyboard for key phrase entry. In process 306, the keys are mapped with a separate display coordinate position to identify a key selected by a user via a pointing input device.

For example, the display coordinate position that is randomly selected for a key can be stored in memory when the keyboard layout of the on-screen keyboard is generated. Thus, based on a tracked location of the pointing input device (e.g., a mouse, a stylus, a user's hand, etc.), the key selected can be determined based on the display coordinate position stored in memory corresponding to the key.

In process 308, the user entered key phrase is received by the user selecting the keys of the keyboard via a pointing input device such as a mouse.

FIG. 3B is a flow chart illustrating a process to generate a keyboard with a random layout of keys, according to one embodiment.

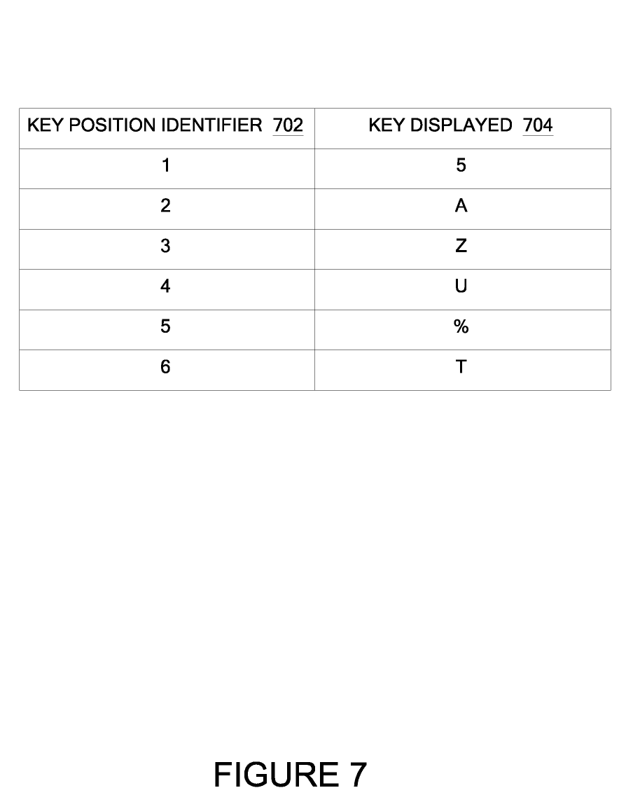

In process 322, display coordinate positions of the keyboard are individually mapped to a separate value within a first value range. For example, the first value range corresponds to the number of positions on a keyboard suitable for placement of the character keys to be placed on the keyboard. In process 324, a random value within the first value range is generated. In process 326, the display coordinate position to place a first key on the keyboard is selected based on the random value generated, as illustrated in the table in FIG. 7.

For example, the display coordinate positions can be associated with an identifier numbered from ‘one’ through the number of display coordinate positions (e.g., a first value range) to be mapped to a key. The random number generator can be called to generate a random number between ‘one’ and ‘the number of display coordinate positions’. The display coordinate position associated with the random number generated can be the location where a key is placed on the keyboard.

In process 328, the remaining keys are mapped to a separate value within a second value range, subsequent to selecting a key for the keyboard based on the random value generated, the second value range is less than the previous value range. For example, after a display coordinate position to place a key on the keyboard has been determined, the first value range can be updated (e.g., decreased by one) such that the same display coordinate position on the keyboard is not mapped to different keys.

In one embodiment, the second value range corresponds to the display coordinate positions yet to be mapped to a key. The second value range may be less than the first value range by at least one iteration.

Other mapping processes to determine a random key placement on a keyboard can be utilized. In one embodiment, the keys (e.g., the character and/or number keys) to be placed on the keyboard can be assigned an identifier within a first value range to be selected by a random number generator. Thus, the key (e.g., character or number) selected by the random algorithm is placed at a particular display coordinate position on the keyboard. The set of identifiers are then mapped to a second value range, such that a key (e.g., the letter ‘a’) is not placed at two separate display coordinate positions on a keyboard, according to one embodiment

The process as illustrated can be repeated to determine the display coordinate positions for additional keys.

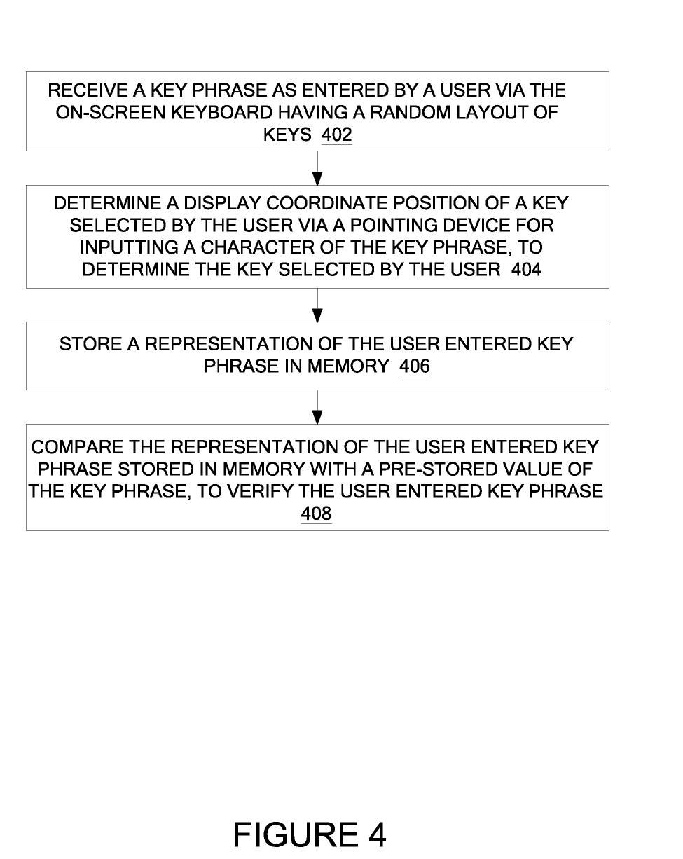

FIG. 4 is a flow chart illustrating a process to verify a key phrase as entered by a user via an on-screen keyboard with a random layout of keys, according to one embodiment.

In process 402, a key phrase as entered by a user via the on-screen keyboard having a random layout of keys is received. In process 404, a display coordinate position of a key selected by the user via a pointing device for inputting a character of the key phrase is determined, to determine the key selected by the user. In one embodiment, the key selected by the user is identified based on the key that is mapped to the display coordinate position, as stored when the keyboard having the random layout of keys is generated.

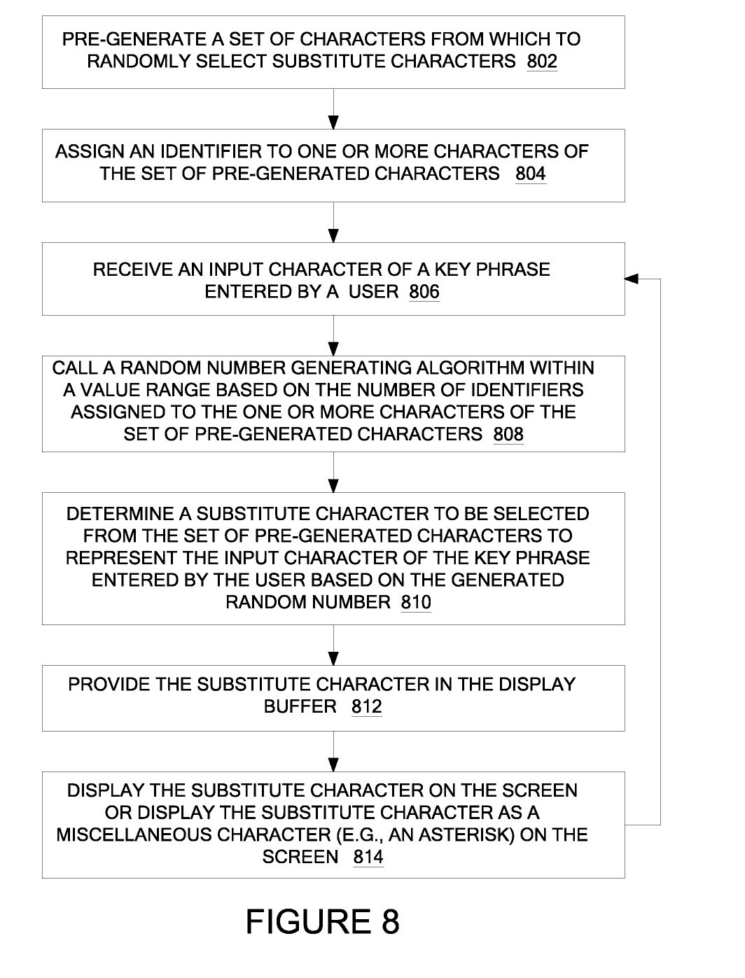

In one embodiment, a set of substitute characters is randomly selected and to be provided in a display buffer in place of the key phrase entered by the user via an on-screen keyboard. The set of randomly selected characters can be determined based on the exemplary process illustrated in FIG. 8.

In process 406, a representation of the user entered key phrase (e.g., a hash value of the user entered key phrase) is stored in memory. In one embodiment, a representation of the set of randomly selected substitute characters is stored in a memory location that is different and separate from where the representation of the user entered key phrase is stored. In process 4408, the representation of the user entered key phrase stored in memory is compared with a pre-stored value of the key phrase, to verify the user entered key phrase.

In one embodiment, a second keyboard having a random layout of keys is generated and displayed, in response to receiving a user entered key phrase that is different from the pre-stored value, at least a predetermined number of times.

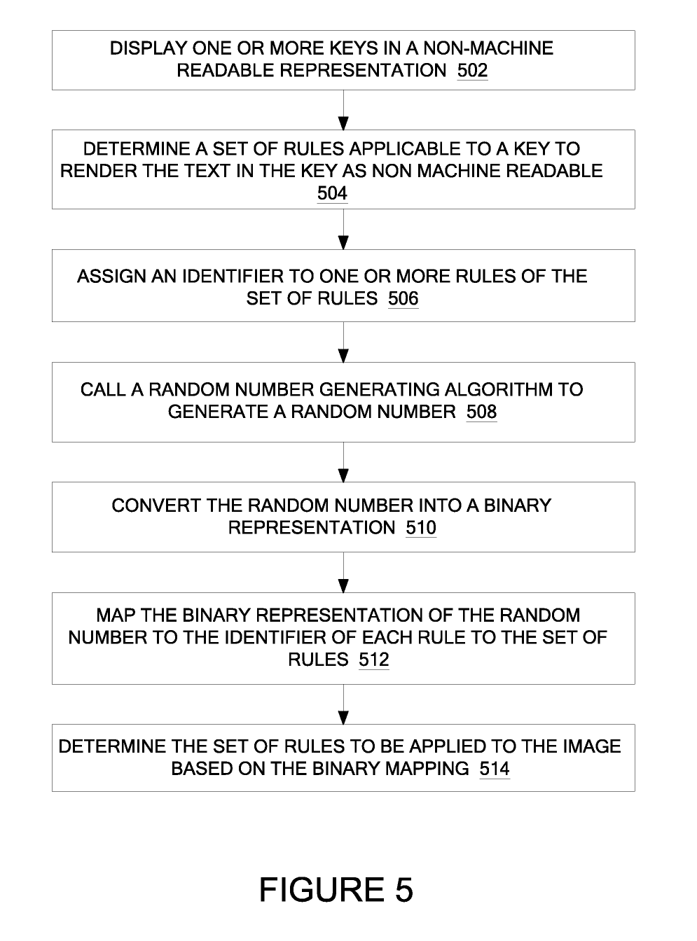

FIG. 5 is a flow chart illustrating a process to determine at least one rule to be applied to a key displayed on the on-screen keyboard to render the characters in the displayed key non-machine readable, according to one embodiment.

As discussed, various strategies can be employed to render the characters in an image as non-machine readable to prevent optical character recognition (OCR) enabled applications and/or scripts from reading the characters. In one embodiment, the non-machine readable representation is a scrambled bitmap. The scrambled bitmap may include colored characters, custom font characters, characters with various color schemes, characters with various backgrounds (e.g., patterned, matte, graded colors, etc.), slanted text, warped text, text with various orientations, etc. Other methods of scrambling bitmaps can be used.

In process 502, one or more keys is to be displayed in a non-machine readable representation. In process 504, a set of rules applicable to a key to render the text in the key as non-machine readable is predetermined. The set of rules can be updated manually or automatically after a predetermined amount of time. In process 506, an identifier is assigned to one or more rule of the set of rules. The identifier can be used to identify the rules during the mapping process to determine the set of rules to be applied to the key. In process 508, a random number generating algorithm is called to generated a random number. The random number can be converted into a binary representation in process 510.

In process 512, the binary representation of the random number is mapped to the identifier of at least one rule of the set of rules. For example, each bit of the binary representation corresponds to the rule as identified by the identifier (e.g., a letter or number). The rule can be chosen depending on whether the bit that corresponds to the rule is ‘1’ or ‘0’. The rule may be chosen when the corresponding bit is ‘1’. Alternatively, the rule may be chosen when the corresponding bit is ‘0’. In process 514, the set of rules to be applied to the image is determined based on the binary mapping.

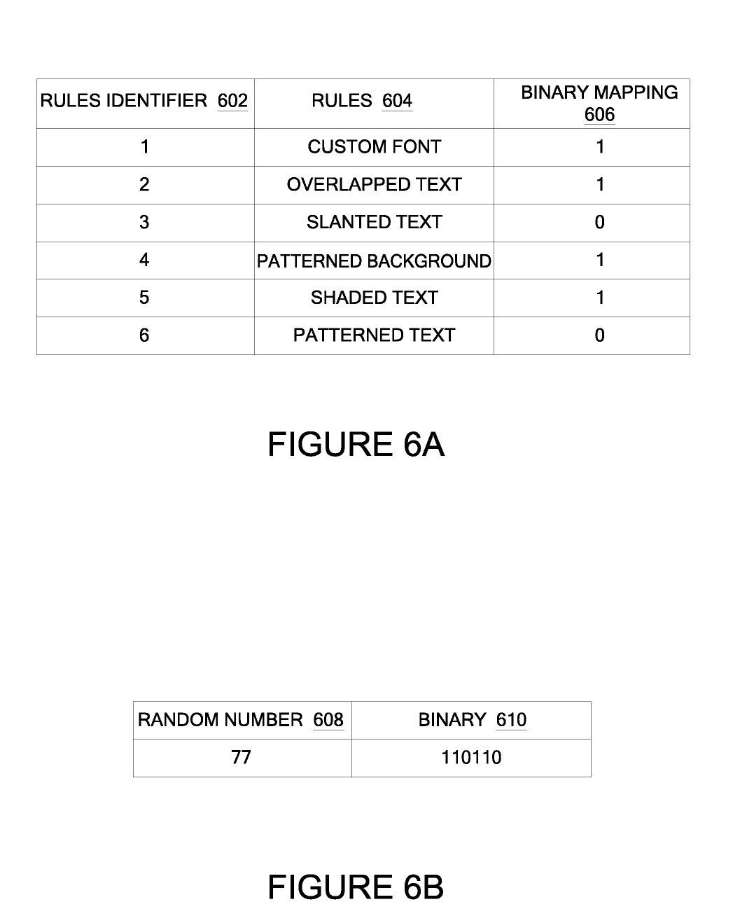

FIG. 6A is a table illustrating an exemplary set of rules 604 to be applied to an image and the binary mapping 606 of the set of rules to determine the rules to be applied, according to one embodiment.

The rules identifier as shown in field 602 can be assigned to the rules in field 604. For example, the rules identifier can be numbers as shown, or a combination of symbols and/or alpha-numerals. The applicable rules include those shown in field 604. Other rules can be included as well. The binary mapping field 606 illustrates the mapping of the binary representation of a random number to the rules to determine the set of rules to be applied to an image.

For example, the binary mapping in field 606 illustrates a binary number ‘110110’ corresponding to the number ‘7’ and ‘7’. Thus, in one embodiment, all the rules are applied except for the slanted text and the patterned text. Alternatively, the zero digits in the binary mapping select the rules to be applied. Thus, the slanted text and the patterned text can be applied to generate the non-machine readable bitmap.

FIG. 6B is a table illustrating a random number 608 and the binary representation of the random number 610, according to one embodiment.

The random number can be generated via any random number generating algorithm. In one embodiment, the range of values within with a random number can be generated is specified based on the number of rules (e.g., the number of rules specified in field 604). The binary number shown in field 610 can be mapped to the rules of field 604 in the binary mapping field 606 to select the rules to be applied to a bitmap image.

FIG. 7 is a table illustrating a mapping of a display coordinate position on a keyboard to a key to be displayed on the keyboard, according to one embodiment.

In one embodiment, display coordinate positions on a keyboard are associated with a key position identifier, as shown in field 702. The key to be displayed at a particular display coordinate position can be assigned to the key position identifier via a random number generating algorithm. For example, to place the key ‘5’, a random number generating algorithm can be called to generate a random number within a first value range (e.g., within the range of 1-6). If the random number generates a ‘1’, the key ‘5’ can be placed at the display coordinate position as identified by the key position identifier ‘1’. To place a key after the display coordinate position for the key ‘5’ has been identified, the random number generating algorithm can be called to generate a random number within a second value range (e.g., the range 2-6). Therefore, the display coordinate position that was mapped to the key ‘5’ will not be remapped to a different key. For example, to determine a location for the letter ‘Z’, the random number generating algorithm can be called to generate a random number within the range of 2-6.

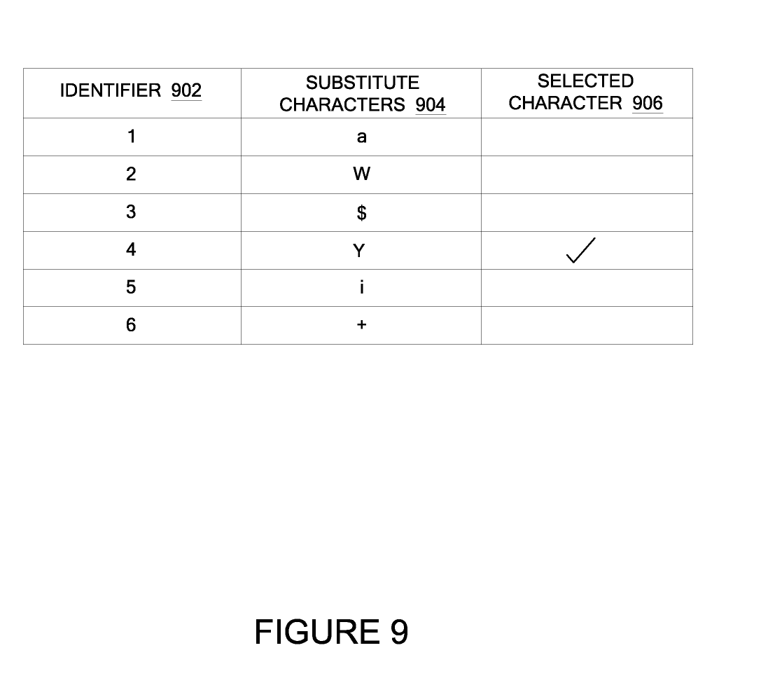

To provide additional security for a user entered key phrase, a set of substitute characters is randomly selected and provided in place of the key phrase entered by the user, via a keyboard having a random layout of keys, according to one embodiment. The set of randomly selected substitute characters can further be provided in a display buffer as the user entered key phrase. In one embodiment, the set of substitute characters are randomly selected according to an exemplary process as illustrated in FIGS. 8-9.

FIG. 8 is a flow chart illustrating a process to randomly select a substitute character to be provided and displayed in place of an input character of a key phrase entered by a user, according to one embodiment.

In general, a random number generating algorithm can be used to select a character to substitute a character of the user entered key phrase to be stored in the display buffer and displayed on the screen (the randomly selected substitute characters may or may not be represented as miscellaneous characters such as asterisks).

In one embodiment, each character of the user entered key phrase is substituted with a randomly selected character. The set of randomly selected substitute characters can include any combination of alpha numerals, special characters, and/or Asian characters. In addition, the substitute characters may or may not be case sensitive.

In process 802, a set of characters from which to randomly select substitute characters is pre-generated. In process 804, an identifier is assigned to one or more characters of the set of pre-generated characters. The pre-generated characters may be re-generated periodically after a pre-determined amount of time. For example, the set of pre-generated characters can be automatically updated or manually updated after the pre-determined amount of time.

In process 806, an input character of a key phrase entered by a user is received. In process 808, a random number generating algorithm is called to generate a random number within a value range. In one embodiment, the value range is based on the number of identifiers assigned to the one or more characters of the set of pre-generated characters.

In process 810, a substitute character to be selected from the set of pre-generated characters to represent the input character of the key phrase entered by the user is determined based on the generated random number. The substitute character is selected, for example, based on the table illustrated in FIG. 9. In process 812, the substitute character is provided in the display buffer. In process 814, the substitute character is displayed on the screen. In one embodiment, the substitute character is displayed as a miscellaneous character (e.g., an asterisk) on the screen. Processes 806 through 814 may be repeated until a substitute character has been randomly selected in place of each character of the user entered key phrase.

FIG. 9 is a table illustrating an exemplary set of pre-generated substitute characters to be randomly selected in place of a user entered key phrase, according to one embodiment.

In one embodiment, the identifiers as shown in field 902 can be assigned to the pre-generated substitute characters in field 904. For example, the identifier can be a number as shown, or a combination of symbols and/or alpha-numerals. The applicable substitute characters include those shown in field 904. Other characters, such as, alpha-numerals, special characters, Asian characters, can further be included. For example, if the identifier ‘4’ is selected, the character ‘Y’ can be selected to substitute for a character in the user entered key phrase.

The identifier ‘4’ as shown in FIG. 9 can be randomly selected via one or more processes. For example, a random number can be generated via any suitable random number generating algorithm to select an identifier associated with a substitute character. In one embodiment, the range of values within with a random number is to be generated is specified based on the number of pre-generated substitute characters (e.g., the number of substitute characters in field 904).

For example, if the random number ‘4’ is generated and corresponds to the identifier ‘4’ in field 902, then the substitute character ‘Y’ is selected in place of a character of the user entered key phrase. The random number generator can be used to select from a substitute character from a pre-generated set of substitute characters for each character, number, or text of the user entered key phrase.

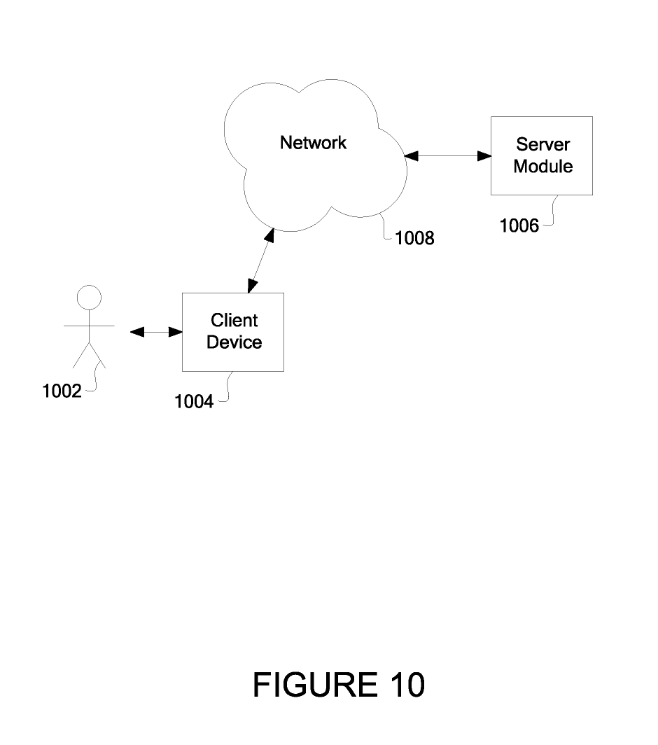

FIG. 10 illustrates an example of implementing at least one embodiment to protect user entered key phrase when attempting to access data via network connection.

The client device 1004 can be any computing device able to access remote data via a network and/or local data residing on the client device. For example, the client device 1004 can be used to access personal financial information via a secure connection with a bank or other types of financial institutes. Additionally, the client device 1004 can be used to access insurance information, health information, and/or other types of data where identity authentication is performed prior to allowing access of requested data. The client device 1004 can be used to store sensitive business related information in various industries such as legal documents, patient information, etc.

In one embodiment, the secure link to accessing the protected data includes a password entry procedure on the client device 1004, to access data locally on the client device or remotely from device/server. The client device 1004 can be any of a PDA, a laptop, a desktop computer, a telephone, a cellular phone, and/or a portable device, etc.

In one embodiment, the server module 1006 provides an on-screen keyboard. The on-screen keyboard can also be provided on the client side (e.g., the client device 1004) to access local data on the client device or remote data stored on a remote server. In one embodiment, an on-screen keyboard can be displayed for input of password characters. The keys on the on-screen keyboard can be selected via a mouse or other pointing devices.

In one embodiment, the on-screen keyboard includes a random layout of keys to receive a user entered key phrase. The random layout can be generated by the client device or the server module. In one embodiment, the client device provides the on-screen keyboard with the random layout of keys to access remote and/or local data. In one embodiment, the server module provides the on-screen keyboard with the random layout of keys to access remote and/or local data.

The keys of the keyboard can be selected via a pointing input device (e.g., a mouse). In one embodiment, a different layout is generated for example, when a logon request is received. In one embodiment, a different layout is applied after a predetermined number of logon attempts are received. In an event of a failed logon attempt, a different layout can be applied to the keyboard. In one embodiment, a different layout is applied after a pre-determined number of failed logon attempts.

The network 1008, over which the client device 1004, and the server module 1006 communicate, may be an open network, such as the internet, or a private network, such as an intranet. In one embodiment, communications to and from the server module achieved by secure communications protocol, such as secure sockets layer (SSL), or transport layer security (TLS).

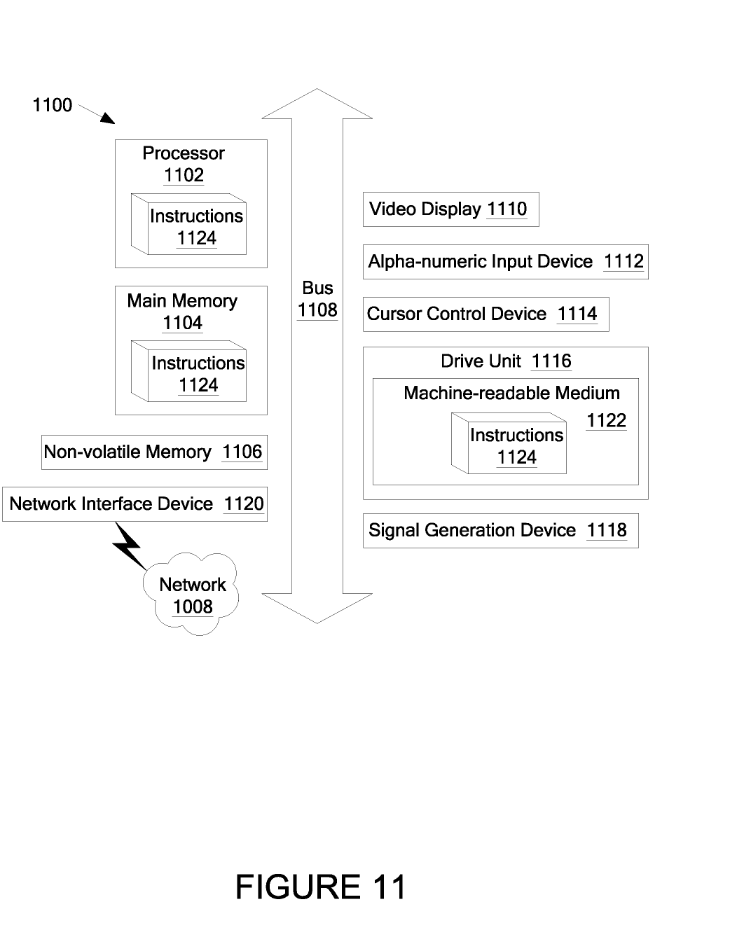

FIG. 11 shows a diagrammatic representation of a machine in the exemplary form of a computer system 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable medium is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
displaying a keyboard comprising a random layout of keys, to receive a user entered key phrase to be entered to gain access to secure data; and
receiving the user entered key phrase by the user selecting keys of the keyboard via a pointing input device.

2. The method of claim 1, wherein the displaying comprises:
individually mapping keys of the keyboard to a separate value within a first value range;
generating a random value within the first value range;
selecting a key for the keyboard based on the random value generated;
repeating the generating the random value and selecting a key for the keyboard based on the random value to select a remainder of keys for generating the random layout of keys for the keyboard.

3. The method of claim 2, further comprising:
disabling a keyboard coupled to a system displaying the keyboard having a random layout of keys.

4. The method of claim 2, wherein the displaying further comprises:
subsequent to selecting a key for the keyboard based on the random value generated, remapping remaining keys to a separate value within a second value range, wherein the second value range is less than a previous value range.

5. The method of claim 4, wherein the second value range is less than the first value range by at least one iteration.

6. The method of claim 1 wherein the displaying further comprises:
mapping each randomly selected key with a separate display coordinate position to identify a key selected by a user via a pointing input device.

7. The method of claim 1, further comprising:
displaying one or more of the keys in a non-machine readable image.

8. The method of claim 7, wherein the displaying the one or more keys in the non-machine readable image comprises displaying the one or more keys in a scrambled bitmap.

9. The method of claim 7, wherein the displaying the one or more keys in the non-machine readable image comprises applying a format to distort the one or more keys.

10. The method of claim 7, wherein the displaying the one or more keys in the non-machine readable image comprises applying a watermark to the one or more keys.

11. The method of claim 7, wherein the displaying the one or more keys in the non-machine readable image comprises applying a format to distort the one or more keys, and applying a watermark to the one or more keys.

12. The method of claim 1, further comprising:
receiving the key phrase input by the user to gain access to secured data; and
in response to receiving the user entered key phrase, randomly selecting a set of substitute characters and providing the set substitute characters in place of the key phrase entered by the user.

13. The method of claim 12, wherein the randomly selecting comprises using a random number generator to select from a substitute character from a pre-generated set of substitute characters for each character, number, or text of the user entered key phrase.

14. The method of claim 12 wherein the providing the set of substitute characters further comprises providing the randomly selected set of substitute characters in a display buffer as the user entered key phrase to be displayed.

15. The method of claim 12, further comprising storing, in a memory of a system, a representation of the user entered key phrase, the representation being different and separate from the randomly selected set of substitute characters.

16. The method of claim 15, further comprising comparing the representation of the user entered key phrase stored in the memory with a pre-stored value, to verify the user entered key phrase.

17. The method of claim 1, further comprising:
in response to receiving an incorrect key phrase a number a predetermined number of times, generating and displaying a second keyboard comprising a random layout of keys.

18. A system, comprising:
a means for, displaying a keyboard comprising a random layout of keys, to receive a user entered key phrase to be entered to gain access to secure data; and
a means for, receiving the user entered key phrase by the user selecting keys of the keyboard via a pointing input device.

19. The system of claim 18, further comprising:
a means for, individually mapping keys of the keyboard to a separate value within a first value range;
a means for, generating a random value within the first value range;
a means for, selecting a key for the keyboard based on the random value generated;
a means for, repeating the generating the random value and selecting a key for the keyboard based on the random value to select a remainder of keys for generating the random layout of keys for the keyboard.

20. A machine readable media embodying instructions, the instructions causing a machine to perform a method, the method comprising:
displaying a keyboard comprising a random layout of keys, to receive a user entered key phrase to be entered to gain access to secure data; and
receiving the user entered key phrase by the user selecting keys of the keyboard via a pointing input device.
